(19) United States
(12) Patent Application Publication
(10) Pub. No.: US 2016/0314700 A1
(43) Pub. Date: Oct. 27, 2016

(54) THERAPEUTIC OBJECTS, METHODS AND SYSTEMS

(71) Applicants: Sean Butler, Kirkwood, MO (US); Sue Butler, Wildwood, MO (US)

(72) Inventors: Sean Butler, Kirkwood, MO (US); Sue Butler, Wildwood, MO (US)

(21) Appl. No.: 15/199,857

(22) Filed: Jun. 30, 2016

Related U.S. Application Data
(63) Continuation-in-part of application No. 15/001,084, filed on Jan. 19, 2016.
(60) Provisional application No. 62/104,071, filed on Jan. 16, 2015.

(51) Int. Cl. G09B 5/12; G09B 5/06

(52) U.S. Cl. CPC G09B 5/125; G09B 5/065

(57) ABSTRACT

Objects, methods and systems are described for an object equipped with embedded or attached tags in combination with a computer application to dynamically (e.g., via rules-based logic) create assign, present, complete, and reward therapeutic task related activities via single or multiple interactions between a user's mobile or other electronic device and a communication tag or tags attached to a physical surface or embedded tags or chips housed within physical objects used for therapeutic purposes.

### CROSS-REFERENCE TO RELATED APPLICATIONS

This application is a continuation in part of U.S. patent application Ser. No. 15/001,084, filed Jan. 19, 2016, which claims the benefit of U.S. Provisional Application No. 62/104,071, filed Jan. 16, 2015, the disclosure of which is incorporated herein by reference.

### BACKGROUND

From a general standpoint, objects, systems and methods are disclosed for creating an engaging, effective learning experience for patients and other users and healthcare providers in the creation, initiation, execution, completion, and reward issuance for therapeutic tasks.

Healthcare therapies are a vital component to any treatment for a plethora of medical conditions. Whether in a hospital, clinical, or home setting, studies have shown that patients benefit the most from therapies in which they are extremely engaged. However, patients are not easily engaged when therapies are either difficult or persistent as is the case with chronic conditions or in the case of pediatric patients or users. In addition, the rising costs of healthcare are forcing patients and families of patients to weigh the costs and benefits of costly intensive therapies and treatments.

Fortunately, the introduction and rapid adoption of numerous, innovative mobile technologies (such as NFC (Near Field Communication), Bluetooth, infrared, and other wireless communication means) will lead to consumers utilizing mobile devices in ways never seen before. Currently, mobile devices are actively being used to send information from a patient to a healthcare provider (or vice versa) from different locations. Although this is a great use of mobile technology, there is still an opportunity to use these new mobile technologies to greatly elevate engagement before, during, and after the actual therapeutic activity undertaken by the patient.

There is an opportunity to utilize emerging mobile technologies to engage patients and healthcare providers in a way never seen before by creating a structured, directed, simple, dynamic and encouraging solution that will lead to improved therapeutic results for users suffering from a wide range of medical conditions. It is highly important for therapeutic purposes for users to have motivation to succeed and learn, monitor their own progress, and initiate and complete tasks that are relevant and of importance to the patient's specific life.

One goal of the present disclosure is to embrace the use of new mobile technologies to offer users and healthcare providers amore engaging and personal experience when creating, initiating, executing, completing, and rewarding therapeutic tasks in any setting.

### DETAILED DESCRIPTION

Disclosed herein are methods, systems, and devices for dynamic content-based learning. In one embodiment, the disclosed methods, systems, and devices include rules-based therapeutic task creation, assignment, presentation, completion and/or reward issuance for therapeutic activities via single or multiple interactions between a user's mobile or other electronic device and tags attached to a physical surface or embedded tags or chips housed within physical objects used for therapeutic purposes. Within the context of this disclosure, the user's mobile device or other electronic device communicates with one or more tags via a wireless communication means, such as RFID, NFC (Near Field Communication), Bluetooth, or the like. Within the context of this disclosure, where NFC is used as an example, it should be understood that RFID, Bluetooth, or other suitable wireless communications means could be used alongside or in place of NFC. In many instances, the choice of over-air or wireless communications technology depends on the choice of mobile device, software, and/or operating system.

Disclosed herein are physical objects, having the ability to contain embedded communications tags or chips, which permit over the air (i.e., wireless) communication with an electronic device. In one embodiment, the object contains an NFC tag. In one embodiment, the object contains an RFID tag. In one embodiment, the object contains a Bluetooth tag, such as an ibeacon.

Also disclosed herein methods, systems, and devices comprising attaching tags or chips, e.g., NFC tags, MID tags, and/or Bluetooth tags or chips, to a physical surface, a mobile device, or other electronic device, such as an electronic device having a processor, memory, and access to computer readable media or transmission network, one or more tags or chips attached to a surface or embedded within a physical object.

In one example, the tags or chips, e.g., NFC tags, RFID tags, and/or Bluetooth tags or chips, have a unique ID, associated with specific therapeutic tasks for the user. In one example, a NFC tag is correlated with specific content for a task via an NFC-enabled device having a mobile or web application containing a user interface. In one example, a RFID tag is correlated with specific content for a task via a RFID-enabled device having a mobile or web application containing a user interface. In one example, a Bluetooth tag is correlated with specific content for a task via a Bluetooth-enabled device having a mobile or web application containing a user interface,

Disclosed herein are methods, systems, and devices for providing a user with the ability to tap an NFC enabled mobile device or other NFC enabled electronic device containing a native or web computer application against a NFC tag or embedded NFC tags or chips to initiate the display of content providing instructions for one or more tasks. Disclosed herein are methods, systems, and devices providing a user with the ability to tap un RFID enabled mobile device or other REID enabled electronic device containing a native or web computer application against an UM tag or embedded RFID tags or chips to initiate the display of content providing instructions for one or more tasks. Disclosed herein are methods, systems, and devices providing a user with the ability to tap a Bluetooth enabled mobile device or other Bluetooth enabled electronic device containing a native or web computer application against a Bluetooth tag or embedded Bluetooth tags or chips to initiate the display of content providing instructions for one or more tasks. In some embodiments, each task comprises one or more steps.

In one embodiment, the methods, systems, and devices are preconfigured by an administrator and generated and presented dynamically from a database or other computer system.

In one embodiment, the content associated with a task includes content chosen from audio, videos, images, text or dynamic instructions. In one embodiment, the said content includes instructions showing the user how to accomplish said task via the native or web application.

In one embodiment of the methods, systems, and devices disclosed herein, the task is broken up into different steps, with each step containing its own content (e.g., audio, videos, images, text and dynamic instructions).

In one embodiment, the user of the methods, systems, and devices disclosed herein advances to the next task(s) or step(s) upon completing a task. For example, once a task or step has been completed, the system may optionally and dynamically, in real time, generate a reward via the native or web application on the NFC-, RFM, or Bluetooth-enabled mobile or other electronic device.

As used herein, the term “reward” means, generally, any positive reinforcement that could be presented to the user upon completing a step or task. Examples of a “reward” within the context of this disclosure include playing audio that says, for example, “Great Job!”, an image of a sticker or prize that the user earned, and/or reward points that could be redeemed for a prize. Within the context of the disclosed methods, systems, and devices, the administrator may setup a custom reward and/or the administrator could choose for the system to generate a random reward from a database.

In some applications, the disclosed methods, systems, and devices create an engaging and more memorable therapeutic experience by equipping physical objects with embedded or attached communication tags, e.g., NFC, RFID, and/or Bluetooth tags. In some embodiments, the methods and systems provide for interacting with particular physical objects to present engaging, customized and dynamic therapeutic tasks to the end user.

In some embodiments of the methods, systems, and devices, the NFC-, RFID-, or Bluetooth-enabled object is first customized by a system administrator and then used by an end user within the disclosed methods, systems, and devices for accessing, executing and/or completing tasks that are presented.

Below, several aspects of the disclosed objects, methods, and systems are exemplified. The objects, methods, and systems are exemplified with reference to “NFC” technology. However, it should be understood that other suitable communications means, such as RFID or Bluetooth may be substituted for the exemplified NFC technology. The particular communication means, e.g., RFID, NFC, or Bluetooth, may be chosen based on the electronic device used within the disclosed objects, systems, and methods. For example, a user with an Android device may use NFC technology whereas a user with an iPhone or iPad device may use Bluetooth technology.

Regardless of the communications means chosen, the signal strength of a particular tag or tagged object may be increased or decreased in order to adjust the distance at which the tagged object is recognized by the electronic device. For example, the signal strength may he increased to provide communication at a greater distance. Alternatively, the signal strength may be decreased in order to provide communication to the user only upon closely approaching an object. By adjusting the signal strength to suit the desired threshold distance for communication, the systems and methods can be configured to accommodate multiple tagged objects within a smaller area.

NFC Enabled Therapeutic Objects

NFC enabled objects are physical objects with attached or embedded NFC tags containing unique tag IDs. The objects can be common non-therapeutic products already in market, common therapeutic products already in market, or customized new products developed specifically for the benefit of the invention.

NFC Enabled Application—Account

In some embodiments of the disclosed methods, systems, and devices, a user account is created with a product key. The product key may function as the unique ID that identifies all NFC enabled objects associated to a user. In one embodiment, the product key includes NIT enabled objects and their unique tag IDs preconfigured in a database so that when the user creates an account, the NFC enabled therapeutic objects are immediately available for the user to customize with tasks and steps.

In one embodiment of the disclosed methods, systems, and devices, a user adds new NFC enabled therapeutic objects to a product key or account via a computer application and user interface.

In one embodiment of the disclosed methods, systems, and devices, a user has the ability to remove NFC enabled therapeutic objects from a product key or account via a computer application and user interface.

In one embodiment of the disclosed methods, systems, and devices, only an account with a product key associated to a NFC enabled therapeutic object and its unique tag id can access tasks or steps configured for that therapeutic object. In one embodiment, a user from a specific account has the option to give access to one or more of the user's NFC enabled therapeutic objects to another account. In one embodiment, a user can also choose to add one or more users to an account to allow further access to specific NFC enabled therapeutic objects.

NFC Enabled Application—Categories

In one embodiment of the disclosed methods, systems, and devices, the user can create categories for the NFC enabled therapeutic objects for a particular account.

A category may be used to create different instances of tasks for specific therapeutic objects. For example, a category may hold different therapeutic content for different therapeutic tasks. In one embodiment, a category may include steps for the same NFC enabled therapeutic objects. One benefit of using categories within a single user account is that the user (or different users) are able to tap a NFC enabled therapeutic object with a NFC enabled mobile or other electronic device, thereby receiving dynamic category-based tasks, based on which category was selected prior to the therapeutic session beginning. A user can create, modify and/or delete a category by using a computer-based user interface, such as a webpage or mobile device application.

NFC Enabled Application—NFC Enabled Therapeutic Objects

In one embodiment of the disclosed methods, systems, and devices, a user is presented with all of the NFC enabled therapeutic objects associated with a particular user account on a user interface.

In one embodiment of the disclosed methods, systems, and devices, a user may customize each therapeutic object within a particular category by adding therapeutic content in the form of one or more steps which must be performed to complete a therapeutic task.

In one embodiment of the disclosed methods, systems, and devices. NFC enabled therapeutic objects can be added or removed from an account from the application.

In one embodiment of the disclosed methods, systems, and devices, an administrator user may define an order for which therapeutic objects should be tapped and accessed by the user.

NFC Enabled Application Tasks

In one embodiment of the disclosed methods, systems, and devices, an NFC enabled therapeutic object includes one or more therapeutic tasks associated to it. In one embodiment of the disclosed methods, systems, and devices, a user can create one or more therapeutic tasks for each NFC enabled therapeutic object in the user's account or an account the user has been given access to. In one embodiment, a task or tasks can be added, modified or removed from a NFC enabled therapeutic object. The therapeutic content for each task can be in the form of images, videos, audio and text. In some embodiments a task is broken down into one or more steps,

NFC Enabled Application—Steps

In one embodiment of the disclosed methods, systems, and devices, each task is broken down into one or more steps with each step having its own unique therapeutic content which could be in the form of images, videos, audio and text.

In one embodiment, the therapeutic content for each step can be added, edited, and removed by the administrator user.

In one embodiment, an administrator user can add or remove steps from a task to further customize the therapeutic object.

In one embodiment, an administrator user can select images, videos, audio and text from native storage or other applications on an NFC enabled mobile or other electronic device.

In one embodiment, an administrator user can create images, videos, audio and text from inside the NFC enabled application on the device through native device features or through third party APIs to other applications.

In one embodiment, an administrator user can select images, videos, audio and text from third party storage sources containing therapeutic content A step can have only text, images, videos, or audio.

In one embodiment, a step includes any combination of text, images, videos or audio. In one embodiment, an administrator user customizes a particular step by choosing therapeutic content and saving the content associated with that specific step, for the applicable task associated to the specific therapeutic object associated to the specific category for the specific user. In one embodiment, when a step is accessed during therapy, the correct step is presented in ascending order until all of the steps are completed. In one embodiment, when a step is presented to an end user, the therapeutic content created by the user is presented on the screen.

NFC Enable Application—Rewards

In one embodiment of the disclosed methods, systems, and devices, a task or step is associated with a reward; the reward is presented to an end user when a task or step is completed. In one embodiment a task is marked completed by the end user or another administrator user that is present during the therapeutic session. In one embodiment, the reward or rewards are in the form of images, videos, audio or text. In one embodiment, the reward is represented as a digital or physical object that can be obtained by the user via the application, a third party application, or from an administrator user. Rewards can be added, modified or removed from a task or step by the administrator user.

NFC Enabled Application—Tapping

In one embodiment of the disclosed methods, systems, and devices, the administrator user selects a category from the application on the device and choose to start a therapy session after a NFC enabled therapeutic object has been configured with therapeutic content in the form of tasks and steps.

In one embodiment of the disclosed methods, systems, and devices, the administrator user provides the NFC enabled device with the application to an end user after a therapy session has begun.

In one embodiment, the end user taps or scans NFC tags or chips attached to or embedded in NFC enabled therapeutic objects—If the end user successfully taps or scans a NFC enabled therapeutic object, the system identifies the user accessing the application by the account, the category that was selected by the administrator, and the unique tag ID that was scanned by the end user. In some embodiments, the system uses this information to immediately generate, load, and play video and audio for the therapeutic content created for the first step of the correct therapeutic task associated to the specific NFC enabled therapeutic object tapped or scanned.

In some embodiments, where a task includes multiple steps to complete a therapeutic task, the end user can progress to subsequent steps in ascending order once a step is completed and the correct therapeutic content (e.g., audio, video, etc.) for each subsequent step is caused to play. In one embodiment, the playing continues automatically until a system defined endpoint is reached.

In one embodiment, the system marks a task or step as completed when the user provides input to the device and application through a swipe, click, additional tap, tap, bodily part movement, or other stimulus created and initiated by the user or administrator and read by the device or application on the device. In some embodiments, the system requires an administrator to decide when a step or task is complete via input such as a swipe, click, additional tap, tap, bodily part movement, or other stimulus.

In some embodiments, the system, methods, and/or devices disclosed herein includes a minimum and/or maximum time limit to complete a step or series of steps before a step or series of steps can be completed. In some embodiments—once a single step or a series of steps has been completed a reward can be presented to the end user via the application.

In some embodiments—after a therapeutic task or the last step of a therapeutic task is completed and optionally a reward is presented—the user can provide input to the device and application through a swipe, click, additional tap, tap, bodily part movement, or other stimulus created and initiated by the user or administrator and read by the device or application on the device to begin scanning or tapping additional NFC enabled therapeutic objects that the user's account has access to.

In some embodiments, the system, methods, and/or devices disclosed herein direct the user through visual or audio cues to the NFC enabled therapeutic objects by requiring the user to tap in the order defined by the administrator user during setup of the task haying a series of steps.

NFC Enabled Application—Reporting

In some embodiments, the system, methods, and/or devices disclosed herein capture metrics and present reports to users surrounding the use of the application by both the end user during a therapy session and administrator activity during the setup of NFC enabled therapeutic objects. Specific types of reports include (but are not limited to) tasks or steps started, tasks or steps not started, tasks or steps not completed, tasks or steps completed, rewards obtained, how long it took to complete a specific task or step, error logs, user interactions with specific tasks or steps, or other applicable measures. In some embodiments, the reports described above are presented to a user via the user interface of the NFC enabled application, through third party APIs, or through a targeted messaging service.

Disclosed herein are objects, methods, processes and systems for dynamic, rules-based therapeutic task creation, assignment, presentation, completion and reward issuance for therapeutic activities via single or multiple interactions between a user's NFC enabled mobile or other electronic device and NYC tags attached to a physical surface or embedded tags or chips housed within physical objects used for therapeutic purposes. In some embodiments, the object, system and/or method comprises a physical object having the ability to contain embedded NFC tags or chips or the ability to attach said NFC tags or chips to its surface, a mobile device or other NFC enabled electronic device having a processor, memory, and access to computer readable media or transmission network; a NFC tag attached to a surface or embedded NFC tags or chips, having a unique ID associated with at least one specific therapeutic task for the user via a mobile or web application containing a user interface.

In some embodiments, a user has the ability to tap an NFC enabled mobile device or other NFC enabled electronic device containing a native or web computer application against a NFC tag or embedded NFC tags or chips to initiate a task(s) preconfigured by an administrator and generated and presented dynamically from a database or other computer system. In some embodiments, the task includes audio, videos, images, text and dynamic instructions showing the user how to accomplish said task via the native or web application. In some embodiments, a task can be broken up and setup as different steps each containing its own audio, videos, images, text and dynamic instructions.

In some embodiments, once the user has completed a therapeutic task or step the user can progress to the next task or step. In some embodiments, once a task or step has been completed, the system may optionally and dynamically, in real time, generate a random or pre-defined reward via the native or web application on the NFC enabled mobile or other electronic device.

in some embodiments, the above-described systems, method, and/or devices further comprise utilizing a native device application or web application allowing a user to create an account and realize or add NFC enabled therapeutic objects to the user's account.

In some embodiments, the above-described systems, method, and/or devices further comprise utilizing a native device application or web application having a process to allow a user to create, modify and delete specific therapeutic categories for one or a group of therapeutic objects. In some embodiments, each category has different therapeutic tasks, steps and therapeutic content for each NFC enabled therapeutic object allowing the system to present dynamic tasks during a therapy session when a NFC enable therapeutic object is tapped or scanned based on the category selected prior to the therapy session beginning.

In some embodiments, the above-described systems, method, and/or devices further comprise utilizing a native device application or web application presenting NFC enabled therapeutic objects associated to the user's account to select and customize with therapeutic content for each category created.

In some embodiments, the above-described systems, method, and/or devices further comprise including a process for the administrator user to add, modify and remove therapeutic objects to and from a user's account. In some embodiments system utilizes a process and database of tag IDs and product keys to associate multiple tag IDs to a specific product key. In some embodiments, a tag ID identifies a specific therapeutic object and a product key associated with a particular user account.

In some embodiments, the above-described systems, method, and/or devices further comprise including a process for the administrator user to start a therapy session once a category has been chosen for one or more NFC enable therapeutic objects.

In some embodiments, the above-described systems, method, and/or devices further comprise including a process for an administrator user to activate the NFC functionality of a NFC enabled mobile or other electronic device so that an end user can begin scanning one or more therapeutic enabled objects associated to the user's account.

In some embodiments, the above-described systems, method, and/or devices further comprise utilizing the application to initiate a process to select a NFC enabled therapeutic object to setup tasks and steps to complete for each category for each NFC enabled therapeutic object. In some embodiments, each task includes multiple steps or rewards each containing one or more multiple images, videos, audio or text to assist the end user in the completion of the step or steps.

In some embodiments, the above-described systems, method, and/or devices further comprise allowing the administrator user to dynamically add, remove, use or not use the number of steps for a therapeutic task on a NFC enabled therapeutic object for a specific category for the administrator user to add images, videos, audio and text to and for the end user to see once a therapy session has begun.

In some embodiments, the above-described systems, method, and/or devices further comprise allowing the user to delete or modify pre-existing images, videos, audio or text for each therapeutic step, task or reward.

In some embodiments, the above-described systems, method, and/or devices further comprise allowing the user to select therapeutic images, videos, audio or text previously captured and stored on the device through native device features and applications to upload to a specific therapeutic step, task or reward.

In some embodiments, the above-described systems, method, and/or devices further comprise allowing the user to capture with the phone's native camera, audio recorder or other native functionality, therapeutic images, videos, audio or text to upload to a specific therapeutic step, task or reward.

In some embodiments, the above-described systems, method, and/or devices further comprise allowing the user to select therapeutic images, videos, audio or text from third party storage sources via APIs for a specific therapeutic step, task or reward.

In some embodiments, the above-described systems, method, and/or devices further comprise utilizing a process for the end user to tap or scan a NFC enabled mobile or other electronic device against a NFC enabled therapeutic object to present the first step to complete a task.

For example, in some embodiments, the system provides a notification via the application or device itself signifying a successful tap or scan of a NFC tag. Accordingly, steps are presented in ascending numerical order. In some embodiments, each step shows content, such as images, videos, audio or text that was setup for that specific NFC enabled therapeutic object for the specific category chosen by the administrator for the specific step number. In some embodiments, the system logically identifies which step's content to present by identifying the user that tapped or scanned the tag, the therapeutic category selected prior to beginning the therapy session, the ID of the attached or embedded NFC tag that was tapped or scanned, then querying a database for the correct therapeutic content, and displaying the correct images, videos, audio and text for that specific step for the task.

In some embodiments—In order for a user to complete a step and move to a subsequent step to complete a therapeutic task, the user provides input to the device and application through a swipe, click, additional tap, tap, bodily part movement, or other stimulus created and initiated by the user or administrator and read by the device or application on the device. In some embodiments, each subsequent step provides the correct therapeutic content in the same logical way as the first step was generated and presented to the end user. In some embodiments, the end user receives a single step in an otherwise larger and more complicated task, making subsequent interactions with the application or therapeutic object to navigate to a subsequent or previous step or task.

In some embodiments, the above-described systems, method, and/or devices further comprise scanning additional NFC enabled therapeutic objects once a final step of a task has been completed signified by end user input to the device and application through a swipe, click, additional tap, tap, bodily part movement, or other stimulus created and initiated by the user or administrator and read by the device or application on the device.

In some embodiments, the above-described systems, method, and/or devices further comprise allowing the user through a swipe, click, additional tap, tap, bodily part movement, or other stimulus created and initiated by the user or administrator and read by the device or application on the device to be navigated to the next sequential step for that specific tag ID, category and user or if the end user is on the final step of a task allow the user to scan additional NFC enabled therapeutic objects associated to the user's account.

In some embodiments, the above-described systems, method, and/or devices further comprise allowing the user through a swipe, click, additional tap, tap, bodily part movement, or other stimulus created and initiated by the user or administrator and read by the device or application on the device to return to a previous step and the user should be navigated to the previous sequential step for that specific tag ID, category and user.

In some embodiments, the above-described systems, method, and/or devices further comprise including the ability for the system to immediately query and load therapeutic content, in real time, including images, videos, audio and text for the specific step accessed. The videos or audio have the ability to auto play after a successful initial tap or scan of a NFC enabled therapeutic object or after progressing to anew or previous step or task.

In some embodiments, the above-described systems, method, and/or devices further comprise utilizing rules to present dynamic tasks, steps and therapeutic content based on when or where the user taps an NFC enabled mobile or other electronic device and a NFC enabled therapeutic object which could include time of day, day of week, month of year, season, holidays, birthdays, past interactions between a NFC enabled mobile or other electronic device, age, condition, medical diagnosis, lack of medical diagnosis, therapeutic needs, breakdown of steps, milestones, thresholds, levels or other useful parameters.

In some embodiments, the above-described systems, method, and/or devices further comprise utilizing a database of predefined therapeutic steps and tasks associated to specific user defined categories with associated images, audio, video, text or other applicable medium, used to automatically customize steps and tasks associated to specific NFC enabled objects and presented to a user's NFC enabled mobile or other electronic device once the end user taps or scans the device against a NFC enabled therapeutic object.

In some embodiments, the above-described systems, method, and/or devices further comprise multiple user accounts for sharing the same therapeutic content library, sharing therapeutic content with other users and accounts, and/or rating or reviewing therapeutic content for other users with other accounts to view and use.

In some embodiments, the system comprises associating specific therapeutic tasks, steps and therapeutic content from one NFC enabled therapeutic object in one account to another NFC enabled therapeutic object in another account.

In some embodiments, the above-described systems, method, and/or devices further comprise a label, sticker, or other marking, containing a NFC tag, securely attached, detached, or reattached to any physical surface.

In some embodiments, the above-described systems, method, and/or devices further comprise using an embedded NFC tag or chip housed within a physical object, allow for the creation, assignment, initiation, completion, and reward issuance of therapeutic tasks.

In some embodiments, the above-described systems, method, and/or devices further comprise NFC tags or chips housed within toys or other visually engaging and mobile objects that can be tapped or scanned by NFC enabled mobile devices or other electronic devices. In some embodiments, these toys or other objects have the ability to produce content, such as therapeutic audio, imagery, video, lighting, or other sensory effects, for example once the device is tapped against a NFC tag or chip.

In some embodiments, the NFC enabled therapeutic objects include a stand or holder designed to hold an NFC enabled mobile device or other electronic device when a tap or scan of a NFC tag or chip is executed. In some embodiments, the NFC enabled therapeutic objects further include attachable, removable, and re-attachable NFC tags or chips, which can be affixed to a variety of surfaces through the use of hooks, adhesives, or other means.

In some embodiments, the objects further include the ability to print or otherwise physically customize the appearance of a label, sticker, or other customizable surface containing/attached to a NFC tag.

In some embodiments, the above-described systems, method, and/or devices further comprise utilizing an application to allow a user to further customize a task or step by allowing the user the option to add a timer to the task overall or for each individual step that would require a minimum or maximum amount of time to complete a task or step for a task. In one example, if the time threshold is not met, a descriptive notification will be generated by the system not allowing a task or step to be completed until the timer is satisfied.

In some embodiments, the above-described systems, method, and/or devices further comprise utilizing an application to allow the user to create a reward for each specific therapeutic task or step. Exemplary rewards include but are not limited to promotions, coupons, points, cash, products, services or other types of incentives or recognition for completing a specific therapeutic task.

In some embodiments, the above-described systems, method, and/or devices further comprise utilizing an application to present reports for specific users, groups of users, categories or other metrics to compare results for reporting purposes such as tasks started, tasks completed, rewards obtained, how long it took to complete a specific task, or other applicable measures. In some embodiments, the system has the ability to send reports and metrics from one account to another account In some embodiments, the system has the ability to obtain (automatically or via user input) user, device, and other relevant information from the user's mobile device to be sent to interested parties when the user completes (or fails to complete) the said therapeutic task.

In some embodiments, the above-described systems, method, and/or comprises an intelligent, programmable Rules Engine for assessing, analyzing, and making decisions on how the therapeutic task was issued, accessed, how information/data was presented/executed, when tasks were initiated, executed, and completed, or other rules or data specific thresholds that may be of interest to a potential user.

In some embodiments, the above-described systems, method, and/or devices further comprise sending reminders and alerts to the user's mobile device based on user activities, user responses or lack of user activities or user responses. In at least one embodiment, the system requests and gathers user-specific details relevant for assist in creating, initiating, and presenting targeted, dynamic, and rules-based therapeutic tasks.

In some embodiments, the above-described systems, method, and/or devices further comprise completion approval. For example, where a task or step requires completion approval, that task or step requires input from a healthcare staff member, parent, or guardian in order to for the user to complete it. In one embodiment, completion approval includes taping a device in a manner identifying the input as coming from a healthcare staff member's, parent's, or guardian's specific phone.

In some embodiments, the above-described systems, method, and/or devices further comprise an NFC external attachment that can be plugged into a mobile or other electronic device if a phone does not have internal NFC capabilities or if the NFC capabilities cannot be accessed. The NFC external attachment allows users to use virtually any mobile or other electronic device with the NFC enabled application to interact with NFC enabled therapeutic objects.

In some embodiments, the above-described systems, method, and/or devices further comprise an API integration and developer toolkit allowing said system to communicate real time with third party mobile applications, web applications, databases, or other related technologies.

Disclosed herein is a teaching system comprising:
a mobile computing device, capable of identifying a communication tag;
at least one communication tag, associated with a specific physical object;
at least one user-defined category;
a database identifying an account associated with the mobile computing device and correlating the at least one communication tag with at least one category associated with the account;
instructional content associated with the combination of the at least one communication tag and the at least one category;
a content player, which automatically plays specific content from database, correlating with the user-defined category and the tag when the mobile computing device identifies the presence of the at least one communication tag;
wherein the instructional content consists of between 1 and 20 steps.

In one embodiment, the disclosed system comprises at least two communication tags, associated with at least two different specific physical objects.

In one embodiment, the disclosed system comprises at least two communication tags, associated with at least three different specific physical objects.

In one embodiment, the disclosed system comprises at least two communication tags, associated with at least four different specific physical objects.

In one embodiment, the disclosed system comprises at least two communication tags, associated with between 5 and 25 different specific physical objects.

In one embodiment, the disclosed system comprises a specific physical object, which is a mobile device holder.

In one embodiment, the disclosed system comprises a specific physical object, which is a toy.

Disclosed herein is a therapeutic method comprising:
enabling a mobile computing device with a communication receiver;
tagging a physical object with a communication tag;
organizing account information, communication tag ID, category, and task information in a database;
playing content upon identifying a user tapping a mobile computing device tagged with a communication tag.

In one embodiment, the disclosed method comprises organizing account information, communication tag ID, category, task information, and step information together in a database.

In one embodiment, the disclosed method comprises playing video content.

In one embodiment, the disclosed method comprises playing audio content.

In one embodiment, the disclosed method comprises displaying a digital image.

In one embodiment, the disclosed method comprises tagging a plurality of physical objects with communication tag.

In one embodiment, the disclosed method comprises physical objects, which are organized by category.

In one embodiment, the disclosed method comprises playing content assigned to the communication tag and also the category.

Although the present invention herein has been described with reference to various exemplary embodiments, it is to be understood that these embodiments are merely illustrative of the principles and applications of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

What is claimed is:

1. A teaching system comprising:
a mobile computing device, capable of identifying a communication tag;
at least one communication tag, associated with a specific physical object;
at least one user-defined category;
a database identifying an account associated with the mobile computing device and correlating the at least one communication tag with at least one category associated with the account;
instructional content associated with the combination of the at least one communication tag and the at least one category;
a content player, which automatically plays specific content from database, correlating with the user-defined category and the communication tag when the mobile computing device identifies the presence of the at least one communication tag;
wherein the instructional content consists of between 1 and 20 steps.

2. The system of claim 1, comprising at least two communication tags, associated with at least two different specific physical objects.

3. The system of claim 1, comprising at least two communication tags, associated with at least three different specific physical objects.

4. The system of claim 1, comprising at least two communication tags, associated with at least four different specific physical objects.

5. The system of claim 1, comprising at least two communication tags, associated with between 5 and 25 different specific physical objects.

6. The system of claim 1, wherein the specific physical object is a mobile device holder.

7. The system of claim 1, wherein the specific physical object is a toy.

8. The system of claim 1, wherein the said instructional content consists of between 1 and 20 steps, which are played in a particular, sequential order.

9. The system of claim 1, comprising a mobile device or web-based programing interface for uploading content to the database and organizing the content according to a communication tag and a user-defined category.

10. A therapeutic method comprising:
enabling a mobile computing device with a communication receiver;
tagging a physical object with a communication tag;
organizing account information, communication tag ID, category, and task information in a database;
playing content upon identifying a user tapping a mobile computing device tagged with a communication tag.

11. The method of claim 10, comprising organizing account information, communication tag IDs, categories, task information, step information and usage in a database.

12. The method of claim 10, comprising playing video content.

13. The method of claim 12, comprising playing audio content.

14. The method of claim 11, comprising, displaying a digital image.

15. The method of claim 10, comprising tagging a plurality of physical objects with a communication tag.

16. The method of claim 15, wherein each of the physical objects is organized by category.

17. The method of claim 10, comprising playing content assigned to the communication tag and also the category.

18. The method of claim 10, comprising uploading content to the database via an input means chosen from a web-based application or application running on a mobile computing device.

19. The method of claim 10, comprising playing content in a predefined, sequential, step-wise order.

20. The method of claim 19, comprising advancing the content from one step to the next step in a sequence by accepting physical input from the user.
